(19) United States
(12) Patent Application Publication
(10) Pub. No.: US 2006/0220597 A1
(43) Pub. Date: Oct. 5, 2006

(54) Cathode-ray tube display apparatus

(75) Inventor: Jae-Wook Jung, Hwaseong-si (KR)

Correspondence Address: ROYLANCE, ABRAMS, BERDO & GOODMAN, L.L.P., 1300 19TH STREET, N.W., SUITE 600, WASHINGTON,, DC, 20036, US

(73) Assignee: Samsung Electronics Co., Ltd.

(21) Appl. No.: 11/316,920

(22) Filed: Dec. 27, 2005

(30) Foreign Application Priority Data
Mar. 8, 2005 (KR) 2005-19344

(51) Int. Cl. H01J 29/70

(52) U.S. Cl. 315/364

(57) ABSTRACT

The present invention relates to a cathode-ray tube display apparatus having a flyback transformer. The apparatus comprises a vertical drive circuit for outputting a predetermined drive current; a vertical output part for outputting a vertical pulse for determining a vertical scanning interval according to an input vertical drive current; a vertical deflection yoke for deflecting a vertical scanning beam according to the vertical pulse; an up/down distortion compensator for generating a compensation signal by overlapping a vertical pulse which has passed the vertical deflection yoke and a horizontal pulse from the flyback transformer, and outputting a vertical drive current to the vertical output part by using the compensation signal and the drive current output from the vertical drive circuit; and a controller for changing a signal gain of the compensation signal generated from the up/down distortion compensator according to a vertical frequency of a recovered broadcasting signal to a predetermined width.

### CROSS-REFERENCE TO RELATED APPLICATIONS

This application claims the benefit under 35 U.S.C. 119(a) of Korean Patent Application No. 2005-0019344, filed on Mar. 8, 2005, in the Korean Intellectual Property Office, the entire content of which is incorporated herein by reference.

### BACKGROUND OF THE INVENTION

1. Field of the Invention

The present invention relates to a cathode-ray tube display apparatus. More particularly, the present invention relates to a cathode-ray tube display apparatus, which efficiently prevents up/down distortion, and compensates for up/down distortion according to a change in a vertical frequency in a slim-type display apparatus having a large deflection angle.

2. Description of the Related Art

A cathode-ray tube display apparatus (to be referred to as a CRT TV as an example thereof hereinbelow) receives a picture signal from an external source, generates an electron beam and displays a picture thereon by colliding the generated electron beam on a fluorescent screen.

As shown in FIG. 1, a CRT TV is largely comprised of a neck 1, a funnel 2 and a panel 3. A lead 4 is formed on a back of the neck 1 to receive a bias according to a picture signal. An electron gun 5 is mounted in the neck 1 to generate an electron beam (B) according to the bias applied through the lead 4 and inject it. Thus, the CRT TV displays a picture as the electron beam B injected from the electron gun 5 passes through dots or stripes formed on a shadow mask 6 mounted in the panel 3, collides with a fluorescent substance of a fluorescent layer 7 corresponding to the electron beam B and generates a light.

Due to differences in a deflection angle resulting from displaying the picture by the electron beam (B) injected by the electron gun 5, the up/down distortion occurs in the CRT TV in which lines of upper/lower parts of the displayed picture are inclined to one side. Thus, the conventional CRT TV has been mounted with horizontal and vertical deflection yokes (H/V-DY) on an outside of the funnel 2 to deflect the electron beam injected from the electron gun 5 through a magnetic field generated from the horizontal and vertical deflection yokes (H/V-DY).

However, if the up/down distortion occurs due to a structural difference of the CRT TV, it is difficult to settle the up/down distortion with the horizontal and vertical deflection yokes (H/V-DY) alone. Referring to FIGS. 2 and 3, a circuit diagram of a conventional up/down distortion compensation will be described to address the up/down distortion resulting from structural differences of the conventional CRT TV.

A vertical output circuit 9 receives a vertical drive current output from a vertical drive circuit 8, and generates a vertical pulse (a) (refer to Graph 3-1 in FIG. 3). Then, the vertical output circuit applies the vertical pulse (a) to a transformer T1 of the up/down distortion compensation circuit. Here, the vertical pulse (a) comprises a vertical synchronous interval (a-1) and a scanning interval (a-2). Also, the transformer T1 of the up/down distortion compensation circuit receives a horizontal pulse (b) (Graph 3-2 in FIG. 3) from a flyback transformer (not shown). The transformer T1 resonates with a capacitor C1 and integrates the horizontal pulse (b), and outputs a compensation vertical pulse (c) overlapped with a compensation pulse (c-1) to a vertical deflection yoke (V-DY) after overlapping an integrated horizontal pulse in the shape of a sine wave and the vertical pulse (a), thereby compensating distortion of the upper/lower parts of the picture.

Recently, the CRT TV has become thinner and has a narrower width between the electron gun 5 and the panel 3 for improving the efficiency of an installation space thanks to development of technology and multimedia, etc. Accordingly, the deflection angle of the electron beam B injected from the electron gun 5 becomes larger than the conventional deflection angle in the slim type CRT TV. Thus, it is required to raise a signal gain of the compensation pulse (c-1) overlapped on the vertical pulse (a) to settle or reduce the up/down distortion in which the upper/lower parts of the picture are more susceptible.

However, the method of settling the up/down distortion of the conventional CRT TV affects not only the scanning interval (a-2), but also the vertical synchronous interval (a-1) in the case where the compensation pulse (c-1) is changed into the compensation pulse (c-2) by raising the signal gain like Graph 3-4 in FIG. 3, thereby generating an unnecessary ripple signal (d) in the vertical synchronous interval (a-1). Thus, a surrounding integrated circuit (IC) receives voltage stress and components able to handle large voltages are required to be used to ease the voltage stress, thereby increasing production costs.

Thus, an economical method of reducing or settling up/down distortions is required.

### SUMMARY OF THE INVENTION

Accordingly, it is an aspect of the present invention to provide a cathode-ray tube display apparatus, which efficiently prevents up/down distortion and compensates for up/down distortion according to a change of a vertical frequency in a slim type display apparatus having a large deflection angle.

Additional aspects and/or advantages of the present invention will be set forth in part in the description which follows and, in part, will be obvious from the description, or may be learned by practice of the present invention.

The foregoing and/or other aspects of the present invention are also achieved by providing a cathode-ray tube display apparatus comprising a flyback transformer. The apparatus comprises a vertical drive circuit for outputting a predetermined drive current; a vertical output part for outputting a vertical pulse for determining a vertical scanning interval according to an input vertical drive current. The apparatus further comprises a vertical deflection yoke for deflecting a vertical scanning beam according to the vertical pulse; an up/down distortion compensator for generating a compensation signal by overlapping a vertical pulse which has passed the vertical deflection yoke and a horizontal pulse from the flyback transformer, and outputting a vertical drive current to the vertical output part by using the compensation signal and the drive current output from the vertical drive circuit; and a controller for changing a signal gain of the compensation signal generated from the up/down distortion compensator according to a vertical frequency of a recovered broadcasting signal to a predetermined width.

According to an aspect of the present invention, the broadcasting signal comprises at least one of a radio frequency (RF) broadcasting signal and a digital broadcasting signal each having a different vertical frequency.

According to an aspect of the present invention, the controller comprises a selection switch for changing the signal gain of the compensation signal generated from the up/down distortion compensator to a predetermined width, and a microcomputer for controlling the selection switch to change the signal gain of the compensation signal to the predetermined width according to a type of recovered broadcasting signal.

According to an aspect of the present invention, the up/down distortion compensator comprises a compensation signal generator for connecting to an end of the vertical deflection yoke, and outputting a compensation signal by overlapping the vertical pulse which has passed the vertical deflection yoke and the horizontal pulse from the flyback transformer; and a feedback circuit for outputting the vertical drive current to the vertical output part by using the compensation signal output from the compensation signal generator and the drive current output from the vertical drive circuit.

According to an aspect of the present invention, the selection switch comprises a gain changer for lowering the signal gain of the compensation signal generated from the compensation signal generator to a predetermined width; and a switch for powering the gain changer on/off according to a control signal from the microcomputer.

According to an aspect of the present invention, the gain changer comprises a capacitor connected with the compensation signal generator in parallel and having a predetermined capacitance, and the switch comprises a transistor wherein an emitter terminal thereof is connected to an end of the capacitor and a base terminal thereof receives the control signal from the microcomputer.

According to an aspect of the present invention, the microcomputer detects a broadcasting signal input from the outside and then recovered, and outputs a low signal to the transistor if input and recovered with a RF signal, and outputs a high signal to the transistor if input and recovered with a digital broadcasting signal.

According to an aspect of the present invention, the compensation signal generator comprises a transformer for outputting an overlapped compensation signal to the feedback circuit by receiving the horizontal pulse from the flyback transformer to a primary coil of the transformer and the vertical pulse which has passed the vertical deflection yoke to a secondary coil of the transformer.

According to an aspect of the present invention, the feedback circuit feedbacks the compensation signal output from the compensation signal generator, and comprises a signal line to output the vertical drive current which is composed with the compensation signal and the driving current output from the vertical drive circuit to the vertical output part.

According to an aspect of the present invention, the horizontal pulse output from the flyback transformer comprises a voltage reverse pulse from a third coil of the flyback transformer.

### BRIEF DESCRIPTION OF THE DRAWINGS

The above and/or other aspects and advantages of the present invention will become apparent and more readily appreciated from the following description of the embodiments, taken in conjunction with the accompanying drawings of which:

FIG. 1 is a side sectional view of a conventional cathode-ray tube (CRT) TV;

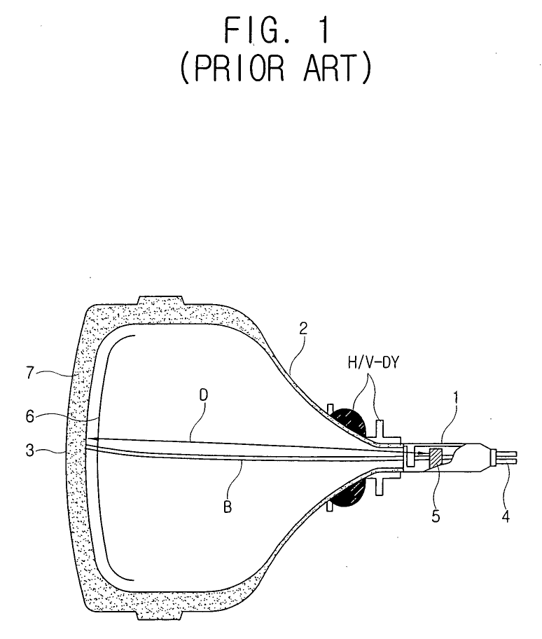

FIG. 2 is a circuit diagram of an up/down distortion compensation of the conventional CRT TV;

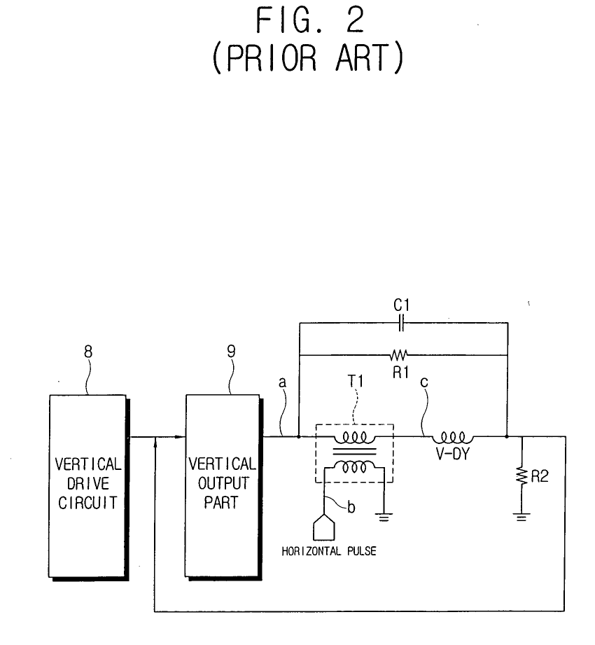

FIG. 3 is graphs illustrating examples of various pulses that occurred during compensation of the up/down distortion in the up/down distortion compensation circuit diagram of the conventional CRT TV in FIG. 2;

FIG. 4 is a circuit diagram of an up/down distortion compensation of a CRT TV according to an embodiment of the present invention; and

FIG. 5 is graphs illustrating examples of various pulses that occurred during the compensation process according to the up/down distortion and the change of the vertical frequency in the circuit diagram of the up/down distortion compensation of the CRT TV according to an embodiment of the present invention in FIG. 4.

Throughout the drawings, the same or similar elements are denoted by the same reference numerals.

### DETAILED DESCRIPTION OF EXEMPLARY EMBODIMENTS

Reference will now be made in detail to the embodiments of the present invention, examples of which are illustrated in the accompanying drawings.

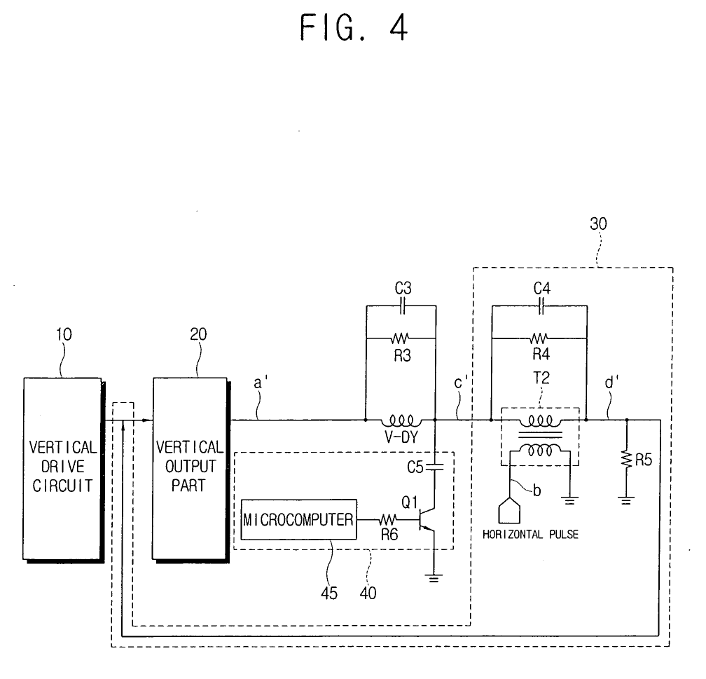

FIG. 4 is a circuit diagram of an up/down distortion compensation of a CRT TV as an example of a CRT display apparatus according to an embodiment of the present invention. As shown therein, the CRT TV according to an embodiment of the present invention comprises a flyback transformer (not shown) for supplying stable direct current voltage to a cathode-ray tube (not shown); a vertical drive circuit 10 to output a predetermined drive current; a vertical output part 20 for outputting a vertical pulse for determining a vertical scanning period according to an input vertical drive current; a vertical deflection yoke (V-DY) for deflecting a vertical scanning beam according to the vertical pulse output from the vertical output part 20; an up/down distortion compensator 30 for generating a compensation signal by overlapping the vertical pulse which has passed the vertical deflection yoke (V-DY) and a horizontal pulse from the flyback transformer (not shown), and outputting a vertical drive current by using the compensation signal and the driving current output from the vertical drive circuit 10 to the vertical output part 20; and a controller 40 for changing a signal gain of the compensation signal generated from the up/down distortion compensator 30 according to a vertical frequency of a recovered broadcasting signal to a predetermined width.

The vertical output part 20 receives the vertical drive current which is combined with the compensation signal output from the up/down distortion compensator 30 and the drive current output from the vertical drive circuit 10, and outputs the vertical pulse for determining the vertical scanning period according to the input vertical drive current to the vertical deflection yoke (V-DY).

The vertical deflection yoke (V-DY) is provided as a coil wound many times, and generates a magnetic field according to the vertical pulse output from the vertical output part 20 and deflects a vertical scanning beam (not shown) from the electron gun 5 to settle the up/down distortion.

The up/down distortion compensator 30 is connected to an end of the vertical deflection yoke (V-DY). The up/down distortion compensator 30 comprises a transformer T2 serving as a compensation signal generator for outputting the compensation signal by overlapping the vertical pulse which has passed the vertical deflection yoke (V-DY) and the horizontal pulse from the flyback transformer (not shown); and a feedback signal line serving as a feedback circuit to output the vertical drive current to the vertical output part 20 by using the compensation signal output from the transformer T2 and the drive current output from the vertical drive circuit 10.

The transformer T2 receives a horizontal pulse corresponding to a voltage reverse pulse from a third coil of the flyback transformer (not shown) to a primary coil of the transformer T2, and a vertical pulse which has passed the vertical deflection yoke (V-DY) to a secondary coil of the transformer T2, and outputs the overlapped compensation signal. At this time, the horizontal pulse output from the third coil of the flyback transformer (not shown) is preferably but not necessarily approximately 100V-200V.

The feedback signal line feedbacks the compensation signal output from the transformer T2, and outputs the vertical drive current which is combined with the compensation signal and the drive current from the vertical drive circuit 10, to the vertical output part 20.

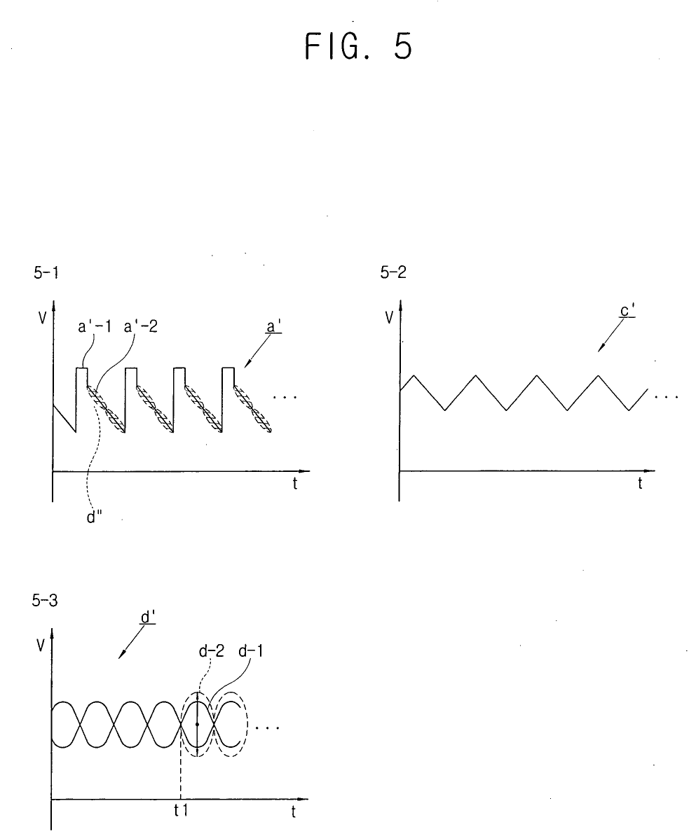

Referring to FIG. 5, the process of compensating for the up/down distortion of the CRT TV of the present invention comprising the up/down distortion compensation circuit will be described through examples of various pulses that occurred during the process of compensating for the up/down distortion.

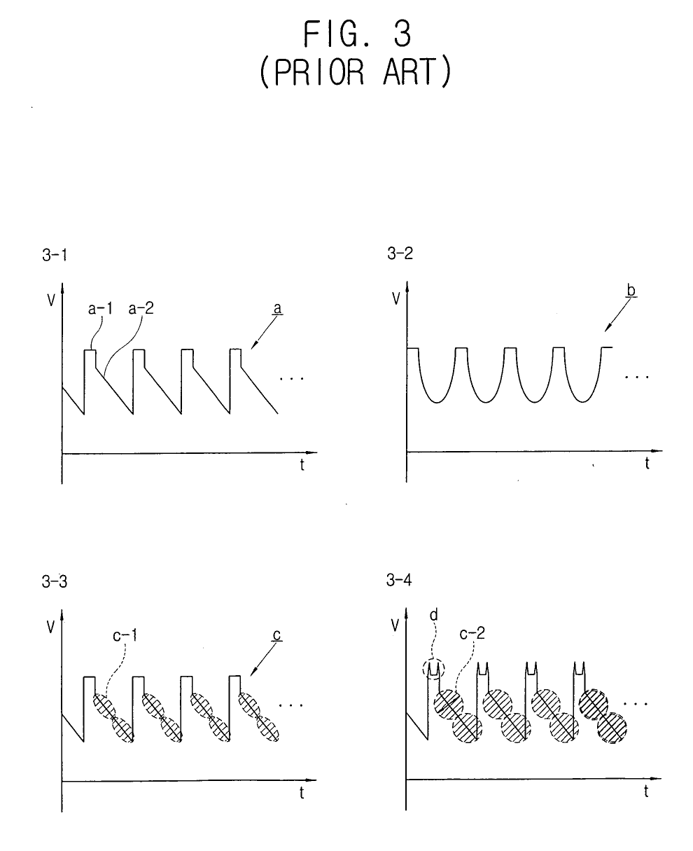

First, a predetermined drive current output from the vertical drive circuit 10 is input to the vertical output part 20 at an initial driving stage. Then, the vertical output part 20 outputs the vertical pulse (a) such as Graph 3-1 in FIG. 3. Thus, the vertical deflection yoke (V-DY) cannot generate the magnetic field for fully compensating the up/down distortion. A vertical pulse (c′) shaped like a triangular wave which has passed the vertical deflection yoke (V-DY) is applied to the transformer T2. Here, the transformer T2 receives the horizontal pulse (b) output from the flyback transformer (not shown) to the primary coil thereof, resonates with a capacitor C4 to integrate the horizontal pulse (b). Then, the transformer T2 changes the horizontal pulse (b) into the shape of a sine wave similar to a parabola. The transformer T2 overlaps the vertical pulse (c′) applied to the secondary coil and the horizontal pulse that was changed into the sine wave, and generates a compensation signal (d′) (refer to Graph 5-3 in FIG. 5) having enough gain. The compensation signal (d′) is combined with the predetermined drive current through the feedback signal line and then input to the vertical output part 20. The vertical output part 20 receives the vertical drive current combined with the compensation signal (d′) and the predetermined drive current output from the vertical drive circuit 10. The vertical output part 20 generates the vertical pulse (a′) (refer to Graph 5-1 in FIG. 5) having a compensation pulse (d″) as an element of the compensation signal (d′) according to the input vertical drive current, and then outputs the vertical pulse (a′) to the vertical deflection yoke (V-DY).

That is, as the vertical output part 20 receives the vertical drive current combined with the compensation signal (d′) and generates the compensation pulse (d″) together with the vertical pulse, the vertical synchronous interval (a′-1) is not affected by the compensation signal (d′) having a larger signal gain, and only the scanning interval (a′-2) is applied with the compensation pulse (d″).

Thus, the vertical deflection yoke (V-DY) generates the magnetic field to fully compensate for the up/down distortion having a large deflection angle by the vertical pulse (a′). The foregoing process of compensating for the up/down distortion is repeated by the transformer T2 and the feedback signal line feedbacking the compensation signal (d′) output from the transformer T2, and the up/down distortion of the picture is settled while driving the CRT TV.

In consideration of the vertical frequency of the input picture signal, element values of the vertical deflection yoke (V-DY), the transformer T2, the capacitors C3 and C4, and the resistances R3 and R4 are designed to generate the compensation signal (d′) having a gain appropriate for settling the up/down distortion of the CRT TV in the slim type CRT TV having the large deflection angle. The element values are fixed when forming the up/down distortion compensation circuit. When generating the compensation signal (d′) having such a large gain as that of the CRT TV of the present invention for compensating for the up/down distortion, the up/down distortion may not be properly compensated for and over-compensation or non-compensation may occur if the broadcasting signal of the vertical frequency is input to be recovered (t1) (refer to Graph 5-3 in FIG. 5). For example, if a broadcasting signal of a vertical frequency lower than the vertical frequency considered while forming the up/down distortion compensation circuit is input, the signal gain of the generated compensation signal becomes large, thereby generating the compensation signal (d-2) having a larger gain than the preferable compensation signal (d-1), and generating over-compensation of the up/down distortion.

The CRT TV according to an embodiment of the present invention comprises a controller 40 for changing the signal gain of the compensation signal generated from the up/down distortion compensator 30 to a predetermined width according to the vertical frequency of the input/recovered broadcasting signal.

As an example of an embodiment of the present invention, the CRT TV receives at least one broadcasting signal of an RF broadcasting signal and a digital broadcasting signal having a vertical frequency lower than that of the RF broadcasting signal to recover the RF broadcasting signal.

The controller 40 comprises a selection switch for changing the signal gain of the compensation signal generated from the up/down distortion compensator 30 to a predetermined width, and a microcomputer 45 for controlling the selection switch to change the signal gain of the compensation signal to a predetermined width according to the recovered broadcasting signal.

The selection switch is provided as a gain changer to lower the signal gain of the compensation signal generated from the transformer T2, i.e. a compensation signal generator, to a predetermined width. The selection switch comprises a capacitor C5 having a predetermined capacitance connected with the transformer T2 in parallel. Also, the selection switch is provided as a switch to turn on/off operation of the gain changer according to a control signal from the microcomputer 45. The selection switch comprises a transistor Q1 wherein an emitter terminal thereof is connected to an end of the capacitor C5 and a base terminal thereof receives the control signal from the microcomputer 45.

The microcomputer 45 detects the broadcasting signal input from the outside. If the broadcasting signal input from the outside is a RF broadcasting signal, the microcomputer 45 outputs a low signal to the transistor Q1. If the broadcasting signal input from the outside is a digital broadcasting signal, the microcomputer 45 outputs a high signal to the transistor Q1.

In the CRT TV comprising the foregoing configuration, the switching process for compensating for the up/down distortion according to the conversion such as the change of the vertical frequency of the input picture signal of the broadcasting signal is as follows:

First, the microcomputer 45 detects the broadcasting signal which is input from the outside and then recovered, through various detection methods such as detection through the synchronous signal of the input broadcasting signal. If it is determined that the recovered broadcasting signal is the RF broadcasting signal, the microcomputer 45 outputs the low signal to the transistor Q1. Then, the capacitor C5 as the gain changer turns off, and the up/down distortion is compensated for by the vertical deflection yoke (V-DY), the transformer T2, the capacitors C3 and C4, and the resistances R3 and R4. In the CRT TV according to an embodiment of the present invention, the element value of respective elements are designed when forming the up/down distortion compensation circuit in consideration of the vertical frequency of the RF broadcasting signal.

If the recovered broadcasting signal is changed into the digital broadcasting signal, the microcomputer 45 outputs the high signal to the transistor Q1. Then, the transistor Q1 turns on, and the signal gain of the compensation signal generated from the transformer T2 by the capacitance of the capacitor C5 as the gain changer is lowered to a predetermined width. When the digital broadcasting signal having the vertical frequency lower than that of the RF broadcasting signal (t1) is input, the compensation signal (d-1) having the lowered signal gain appropriate for the compensation is generated, thereby preventing the compensation signal (d-2) increased in the signal gain by the low vertical frequency from being generated, and preventing the over-compensation of the up/down distortion.

As the capacitance of the capacitor C5 becomes larger, the width to lower the signal gain of the compensation signal becomes larger. Thus, it is preferable but not necessary to design the capacitor C5 to have the appropriate capacitance based on the vertical frequency of the digital broadcasting signal.

The CRT display apparatus of the present invention comprising the foregoing configuration does not directly overlap the horizontal pulse to the vertical pulse (a), thereby not affecting the compensation pulse (d″) in the vertical synchronous interval (a′-1) even though the signal gain of the compensation signal is raised. Also, the rise of the temperature of the surrounding IC and various stress may be settled by using the horizontal pulse having a low voltage in the range of 100V-200V to generate the compensation signal (d′) as compared with using high voltages.

Regardless of the change of the vertical frequency of the input picture signal, the compensation signal having the optimal signal gain appropriate for the up/down distortion compensation is constantly generated, thereby preventing over-compensation or non-compensation.

Although exemplary embodiments of the present invention have been shown and described, it will be appreciated by those skilled in the art that changes may be made in these embodiments without departing from the principles and spirit of the invention, the scope of which is defined in the appended claims and their equivalents.

What is claimed is:

1. A cathode-ray tube display apparatus comprising a flyback transformer, comprising:
a vertical drive circuit for outputting a predetermined drive current;
a vertical output part for outputting a vertical pulse for determining a vertical scanning interval according to an input vertical drive current;
a vertical deflection yoke for deflecting a vertical scanning beam according to the vertical pulse;
an up/down distortion compensator for generating a compensation signal by overlapping a vertical pulse which has passed the vertical deflection yoke and a horizontal pulse from the flyback transformer, and outputting a vertical drive current to the vertical output part by using the compensation signal and the drive current output from the vertical drive circuit; and
a controller for changing a signal gain of the compensation signal generated from the up/down distortion compensator according to a vertical frequency of a played broadcasting signal to a predetermined width.

2. The cathode-ray tube display apparatus according to claim 1, wherein the broadcasting signal comprises at least one of a radio frequency (RF) broadcasting signal and a digital broadcasting signal having a different vertical frequency.

3. The cathode-ray tube display apparatus according to claim 2, wherein the controller comprises a selection switch for changing the signal gain of the compensation signal generated from the up/down distortion compensator to a predetermined width, and a microcomputer for controlling the selection switch for changing the signal gain of the compensation signal to the predetermined width according to a type of played broadcasting signal.

4. The cathode-ray tube display apparatus according to claim 3, wherein the up/down distortion compensator comprises a compensation signal generator provided for connecting to an end of the vertical deflection yoke, and outputting a compensation signal by overlapping the vertical pulse which has passed the vertical deflection yoke and the horizontal pulse from the flyback transformer; and a feedback circuit for outputting the vertical drive current to the vertical output part by using the compensation signal output from the compensation signal generator and the drive current output from the vertical drive circuit.

5. The cathode-ray tube display apparatus according to claim 4, wherein the selection switch comprises a gain changer for reducing the signal gain of the compensation signal generated from the compensation signal generator to a predetermined width; and a switch for turning the gain changer on/off according to a control signal from the microcomputer.

6. The cathode-ray tube display apparatus according to claim 5, wherein the gain changer comprises a capacitor connected with the compensation signal generator in parallel and having a predetermined capacitance, and the switch comprises a transistor wherein an emitter terminal thereof is connected to an end of the capacitor and a base terminal thereof receives the control signal from the microcomputer.

7. The cathode-ray tube display apparatus according to claim 6, wherein the microcomputer detects a broadcasting signal input from the outside and then plays the signal, and outputs a low signal to the transistor if input and played with a radio frequency (RF) signal.

8. The cathode-ray tube display apparatus according to claim 7, wherein the compensation signal generator comprises a transformer for outputting an overlapped compensation signal to the feedback circuit by receiving the horizontal pulse from the flyback transformer to a primary coil of the transformer and the vertical pulse which has passed the vertical deflection yoke to a secondary coil of the transformer.

9. The cathode-ray tube display apparatus according to claim 8, wherein the feedback circuit comprises a signal line to feedback the compensation signal output from the compensation signal generator, and to output the vertical drive current which comprises the compensation signal and the driving current output from the vertical drive circuit to the vertical output part.

10. The cathode-ray tube display apparatus according to claim 9, wherein the horizontal pulse output from the flyback transformer comprises a voltage reverse pulse from a third coil of the flyback transformer.

11. The cathode-ray tube display apparatus according to claim 6, wherein the microcomputer detects a broadcasting signal input from the outside and then plays the signal, and outputs a high signal to the transistor if input and played with a digital broadcasting signal.

12. The cathode-ray tube display apparatus according to claim 11, wherein the compensation signal generator comprises a transformer for outputting an overlapped compensation signal to the feedback circuit by receiving the horizontal pulse from the flyback transformer to a primary coil of the transformer and the vertical pulse which has passed the vertical deflection yoke to a secondary coil of the transformer.

13. The cathode-ray tube display apparatus according to claim 12, wherein the feedback circuit comprises a signal line to feedback the compensation signal output from the compensation signal generator, and to output the vertical drive current which comprises the compensation signal and the driving current output from the vertical drive circuit to the vertical output part.

14. The cathode-ray tube display apparatus according to claim 13, wherein the horizontal pulse output from the flyback transformer comprises a voltage reverse pulse from a third coil of the flyback transformer.
